(19) United States
(12) Patent Application Publication
(10) Pub. No.: US 2014/0024313 A1
(43) Pub. Date: Jan. 23, 2014

(54) Data Collection Network For Agriculture And Other Applications

(71) Applicant: Green Badge LLC, King of Prussia, PA (US)

(72) Inventor: Jeffrey Campbell, Boise, ID (US)

(21) Appl. No.: 13/942,696

(22) Filed: Jul. 15, 2013

Related U.S. Application Data
(60) Provisional application No. 61/674,272, filed on Jul. 20, 2012.

(51) Int. Cl. H04B 1/38

(52) U.S. Cl. CPC H04B 1/3822
USPC 455/41.2

(57) ABSTRACT

A data collection network for agriculture and other applications is disclosed herein. Multiple monitors positioned in an area receive an energy signal from a receiver of a transport device. The energy signal powers a wireless signal from the transceiver of the monitor to the transceiver of the transport device. The wireless signal comprises soil data for the geographical area

### CROSS REFERENCE TO RELATED APPLICATION

The Present application claims priority to U.S. Provisional Patent Application No. 61/674,272 filed on Jul. 20, 2012, which is hereby incorporated by reference in its entirety.

### STATEMENT REGARDING FEDERALLY SPONSORED RESEARCH OR DEVELOPMENT

Not Applicable

### BACKGROUND OF THE INVENTION

1. Field of the Invention

The present invention generally relates to agriculture data collection.

2. Description of the Related Art

The prior art discusses other irrigation systems and methods.

Center pivots have been used in agriculture to water fields.

Sensors are used in fields to provide soil measurements. However, these sensors require a power source such as a battery, to provide soil data.

### BRIEF SUMMARY OF THE INVENTION

The present invention provides a system for a data collection network for agriculture and other applications. There are many advantages to a data collection system where the receivers are not stationary but move through predictable or controllable paths, especially in any application where a drone, manned vehicle, or equipment travels regularly across an area that needs to be monitored.

One aspect of the present invention is a sensor. The sensor has at least one or more of the following attributes: energy harvesting, proximity triggering, sensor communication/triggering, and low RF power sensor.

Sensors preferably harvest energy, and are equipped with receiving antennas/coils and associated circuitry that allow the sensor to absorb and store electromagnetic energy. Upon absorbing sufficient energy, the sensor can awaken, make a measurement, and communicate the reading. The advantages to energy harvesting are the elimination of the cost involved with batteries, ease of maintenance (no need to change batteries), the small size, and simplified encapsulation of electronics. The stimulating coil is collocated with the receiver and the monitor only transmits when the relative distance of separation between the monitor and the receiver is small allowing for a strong communication link. Further, the system utilizes very low power simple radio transmission links that require no FCC license, allows the sensor to have no internal time-keeping that determines when the sensor must transmit by transmitting only when the mobile receiver is nearby it helps to reduce radio network traffic, and since the energy harvesting range is typically quite low, the monitor data packet (wireless signal) doesn't not need to contain a network address indicating it's specific identity as this is known from the mobile receiver position.

Alternatively, the sensors are configured with a receiving antenna/coil or suitable sensor, such as acoustic or infrared, that has an extremely low electrical power requirement. Upon receiving a stimulating signal from a mobile receiver, the sensor triggering circuitry generates an activate signal for the sensor to power up, perform a measurement, and communicate the result. The advantages in proximity triggering are the same as energy harvesting except that proximity triggering does not eliminate the need for batteries (however the batteries are substantially smaller than a typical sensor battery).

Alternatively, in sensor communication/triggering, as the mobile receiver is capable of moving into close proximity of the sensor prior to the sensor communicating, alternative communication schemes are possible, such as acoustic, infrared, or other communication approach. The advantage is that very inexpensive transducers are used to accomplish the link without requiring any RF energy emissions and the associated licensing and limited design specifications required by the many different controlling authorities in a global market.

Alternatively, the monitors do not contain energy harvesting or triggering circuitry but operate under their own power with regular sensor measurements and RF transmission of the readings that occur at regular periodic intervals. These low RF power monitors still benefit from the mobile receivers in that they use much lower RF transmit power levels to communicate with the mobile receivers when the mobile receivers move to within close proximity during one of the regular transmit events.

Another aspect of the present invention is a mobile receiver which is a device that communicates with the monitors and record measurements. The mobile receive is placed on a transport mechanism that is not intended to be in a fixed location, such as irrigation center pivots, lateral lines, tractors, harvesters, motor vehicles, field man-transportable devices, as well as autonomous or semi-autonomous vehicles (drones).

Alternatively, mobile receivers store data for extended periods prior to wireless communication along the network backbone or via a wired download to a shuttle unit that is used to later upload the data to the cloud or other control/storage device from a convenient location.

Alternatively, the mobile receivers display some of the data, as well as communicate with a network backbone to the cloud or other control/interpretation device.

Yet another aspect of the present invention is a drone. Drones are mobile receivers placed on manned or unmanned ground or aerial vehicles which travel along a course that brings them into close proximity of the sensors such that, depending on sensor type, the drone's mobile receiver either receives a sensor's regularly scheduled data transmission, or stimulates transmission through either a proximity trigger or by the sensor harvesting enough energy from a stimulating coil to trigger a transmission.

The drones allow a single mobile receiver to monitor a geographically large area in an economical manner by employing either very low power RF sensor transmission or communication through acoustics, infrared, etc. Additionally, because the drone can alter its path, the drone can respond dynamically and, for example, intensively monitor a small sub-region of the monitored area intensively during dynamic events that need to be carefully characterized.

Alternatively, the drone communicates data as the data is collected via the network backbone or of storing the data until the drone returns to a base where the data is uploaded into the cloud or into a storage/control unit.

Alternatively, the path over which the drone travels (or over which the user is directed to steer) may in turn be sensor-data dependent, such that the data, as it is collected, may be used with certain algorithms to alter the path traveled to capture data in a more efficient or useful manner.

Yet another aspect of the present invention is a hybrid configuration. In many applications hybrid deployments, consisting of mobile receivers as well as fixed location receivers, are employed with varying types of sensors including relatively conventional, battery powered, higher RF transmission powered, and regular interval reporting sensors. The hybrid approach allows for continuous, long term monitoring of a particular location as opposed to the case with mobile receivers where only sensors currently very nearby may be able to make and communicate measurements which can result in long intervals between successive measurements of individual sensors. Additionally, the fixed receivers can also be used in conjunction with the mobile receivers as repeaters to help carry data from remote locations as part of the network backbone.

Yet another aspect of the present invention is a network backbone, which allows for communication of sensor data that is received directly by the mobile receivers (or other fixed receivers in a hybrid installation) to a data storage/control unit or into the cloud. This is accomplished in a variety of ways including wired connections between mobile receivers (particularly when they are installed on a large moving structure such as a center pivot), by using mobile receivers and fixed receivers in some installations as data repeaters. When operating as data repeaters the receivers transmit sensor data received directly from the sensors, utilizing, possibly, a different radio communication band (433 MHz, 933 MHz, 2.4 GHz, etc.) as well as echoing sensor data received from other mobile receivers so as to from a range extending communication network. Additionally, some mobile or fixed receivers may function as a bridge to the cloud, using either a wired internet connection, cell phone modem, or other connection.

While the present invention contained herein is geared towards agricultural applications, the embodiments can extend to numerous other applications, such as, sports or recreational turf, environmental monitoring of landfills, waste sites, or the like, transportation infrastructure (e.g., roads, railways), industrial process control, and many others.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is a diagram of a center pivot application of the present invention.

FIG. 2 is a diagram of a drone application of the present invention.

FIG. 3 is an image of a wireless sensor application of a center pivot system of the present invention.

FIG. 4A is an image of an embodiment of the present invention using a tractor.

FIG. 4B is an image of an embodiment of the present invention using drones.

FIG. 5 is a diagram of an energy savings system of the present invention.

FIG. 6 is a diagram of energy harvesting of the present invention.

FIG. 7 is a diagram of a preferred embodiment of a wireless sensor network of the present invention.

### DETAILED DESCRIPTION OF THE INVENTION

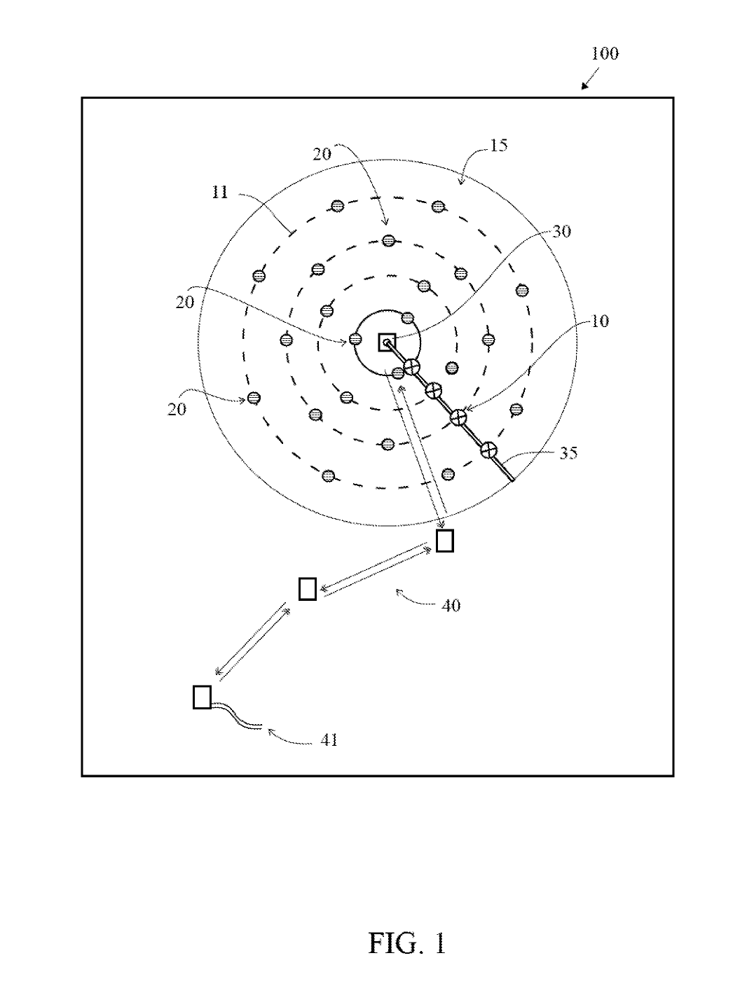

FIG. 1 illustrates an application of a data collection network in a center pivot system 100. An irrigation boom 35 (center pivot) travels in a circular path of a field 15, as shown, and multiple energy harvesting monitors 20 are positioned in the field 15. Multiple mobile receivers 10 positioned on the irrigation boom 35 travel on a fixed path 11. The mobile receivers 10 collect data from the monitors 20 and communicate along a wire on the irrigation boom 35 to a central location at the center of the pivot. In this configuration, the energy harvesting monitors 20 are located strategically on the path 11 of the mobile receivers 10 such that the mobile receivers 10 pass directly overhead and stimulate a transmission from the monitor 20 after the sensor has absorbed sufficient energy from the stimulating antenna on the mobile receiver 10. The mobile receiver 10 communicates over a wired connection to a fixed repeater 30 at the center of the center pivot which then relays the data, wirelessly from repeater to repeater, along the network backbone 40 until encountering a repeater that has a connection to the internet, and in this case, a wired Ethernet connection 41. In this manner, the monitors 20, which comprise at least one sensor capable of measuring soil parameters, relay soil data to a central location without the need for a battery.

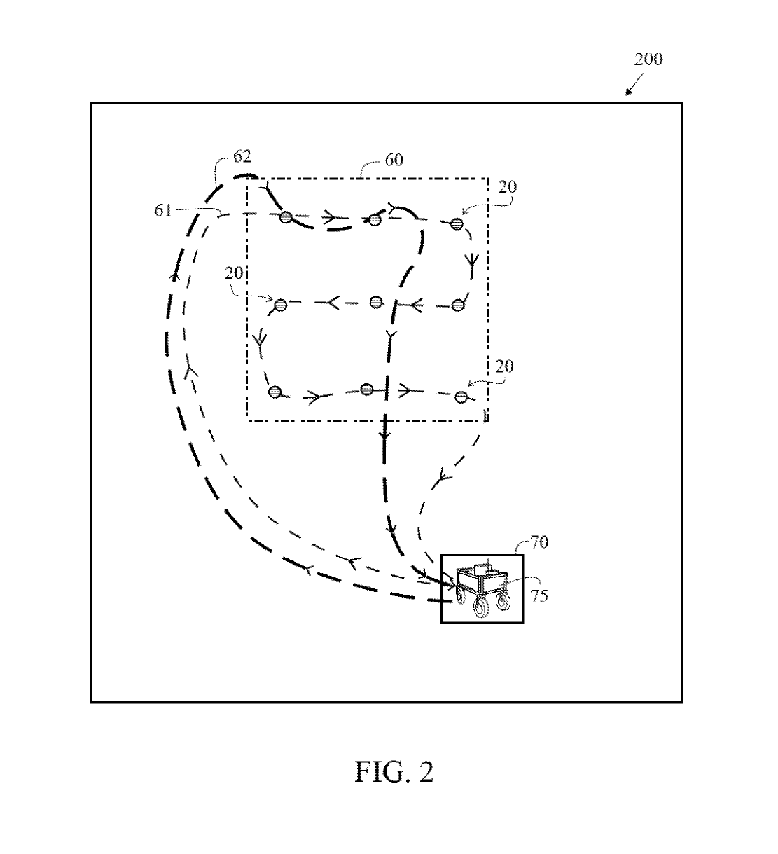

FIG. 2 illustrates an application 200 of a data collection network involving an autonomous surface travelling drone 75 with data dependent paths and utilizing energy harvesting monitors 20. The first path 61 results when collected soil moisture values are considered within nominal desired ranges. The alternate path 62 shown is triggered by very low soil moisture values in the first three monitors, which results in the drone returning to base 70 to report the urgent need for irrigation.

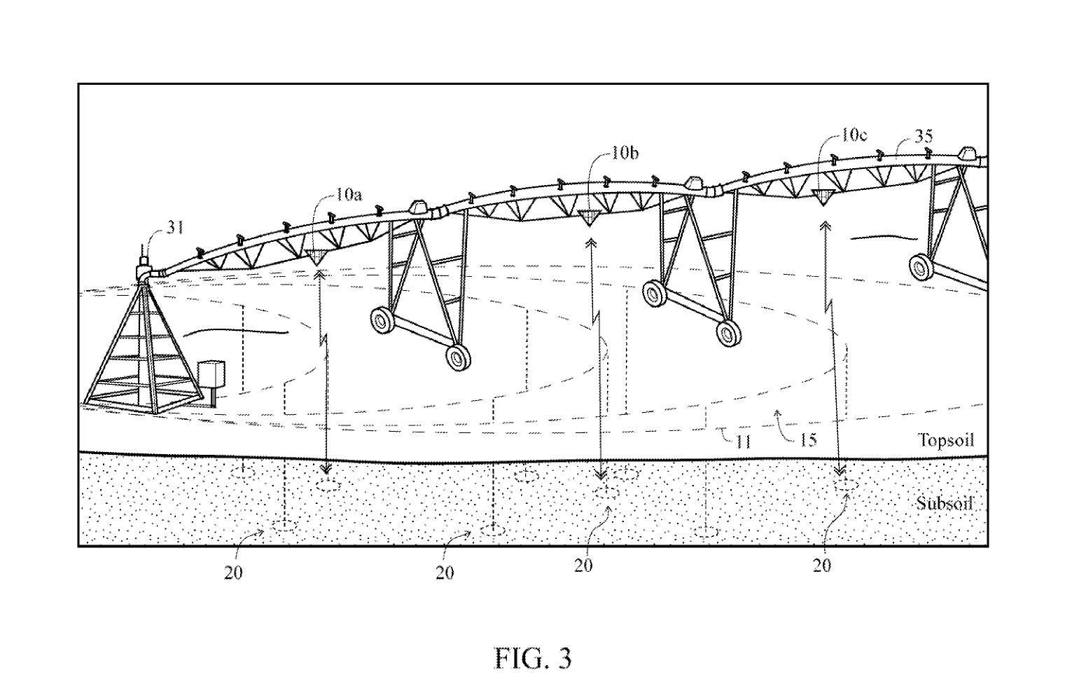

FIG. 3 illustrates a wireless sensor application of a data collection network of a center pivot system. The center pivot 35 structures rotate through a field 15 on very predictable course 11. Receivers 10a-10c are placed at numerous locations down the length of the center pivot 35. Subterranean monitors 20 are placed at strategic locations and as the center pivot 35 rotates through the field 15, it passes directly over the monitors 20 (to preferably place monitor, a receiver is installed ten feet inside the second wheel and then the wheel tracks are utilized as a guide in the field to place monitors, where desired, preferably ten feet inside). Also, since power is always available at the middle of the center pivot 35, it is easy to run cable down the top to power all the receivers 10a-10c down the line. Furthermore the receivers 10a-10c are preferably passive radio listeners and relay the information to the center over the wire which reduces costs, FCC headaches, and network management issues, and a single “bridge” 31 at the center relays the information using 933 MHz, a GSM modem, etc.

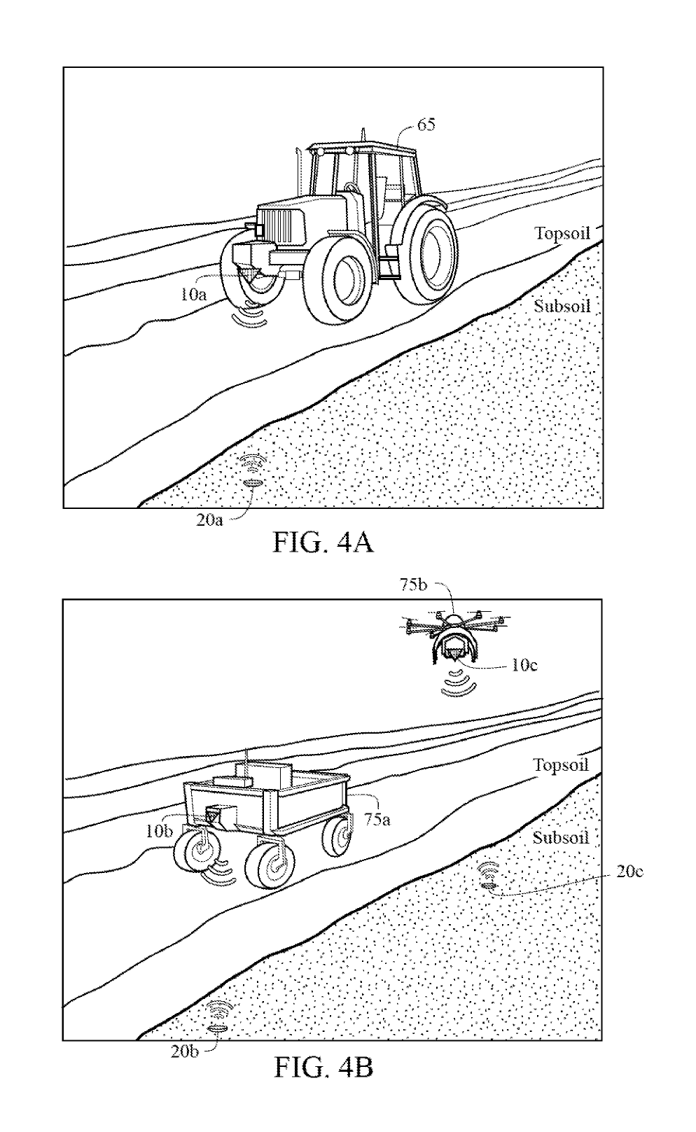

FIG. 4A and FIG. 4B also illustrate the wireless sensor network in application of a data collection network system. In FIG. 4A, a tractor 65 with a receiver 10a picks up information from a subterranean monitor 20a as the receiver 10a passes directly over the monitor 20a. FIG. 4B shows the same application as FIG. 4A with the use of drones, a terrestrial drone 75a with a receiver 10b and an aerial drone 75b with a receiver 10c, which communicate with the monitor 20b-20c that the drones are passing directly over.

There are many advantages to such a mobile network. First, the required communication range of the sensors is dramatically lower-1 to 2 meters as opposed to about 100 meters, and the geometry is far more favorable due to the directly overhead positioning as opposed to very low elevation angles in current repeaters with respect to sensors. Because this range and geometry is so much more favorable, this dramatically decreases sensor radio transmit power levels which allows for the use of smaller batteries and power management circuitry as well as optionally a whole new range of communication frequencies and approaches that would be precluded if higher power levels (including ones that might allow for sensor to be placed at much greater depths) were needed for transmission. The present invention also allows for the elimination of expensive radio interface chips through the use of very simple uC implemented techniques like frequency shift key approaches that are inexpensive.

The network topology is also simpler than current techniques. Using a wired connection for the repeaters (which in this case would be better called “Listeners”) allows all of the repeaters to have a direct connection (with no hops) to the bridge at the middle of the center pivot. There is no concern about the echo chamber issues with repeaters, how to configure or repair the network. The very limited sensor power transmit levels are low and the associated very short range transmissions is favorable in that only sensors in the ring directly beneath the repeater, and only the one currently very nearby, can be heard by that repeater. Thus, there is no concern about multiple repeaters hearing the same sensor packet. Also, since the repeater that picks up the sensor is known, the sensor's location is also known. This eliminates having to send identifying sensor network address messages.

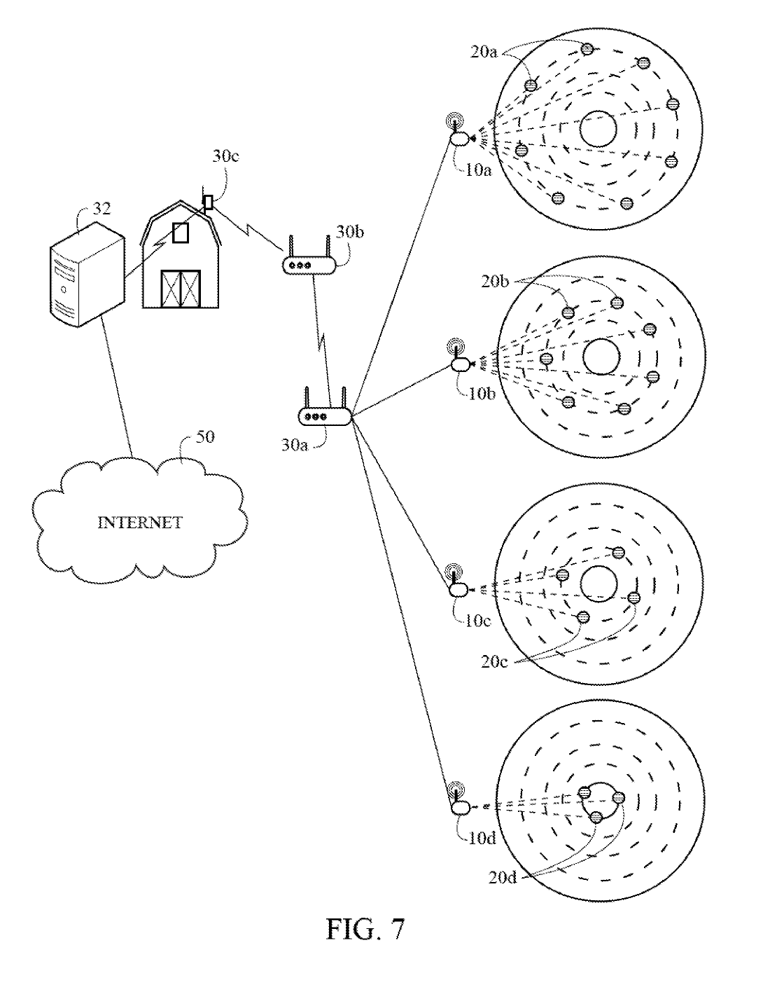

FIG. 7 shows an embodiment of the wireless sensor network of the present invention. Mobile receivers 10a-10d receive data from monitors 20a-20d as the receiver pass over the monitors. The receivers communicate with the repeater 30a nearest to them and the transmission of data continues to other repeaters 30b-30c until it reaches a base station gateway 32 that is connected to the Internet 50.

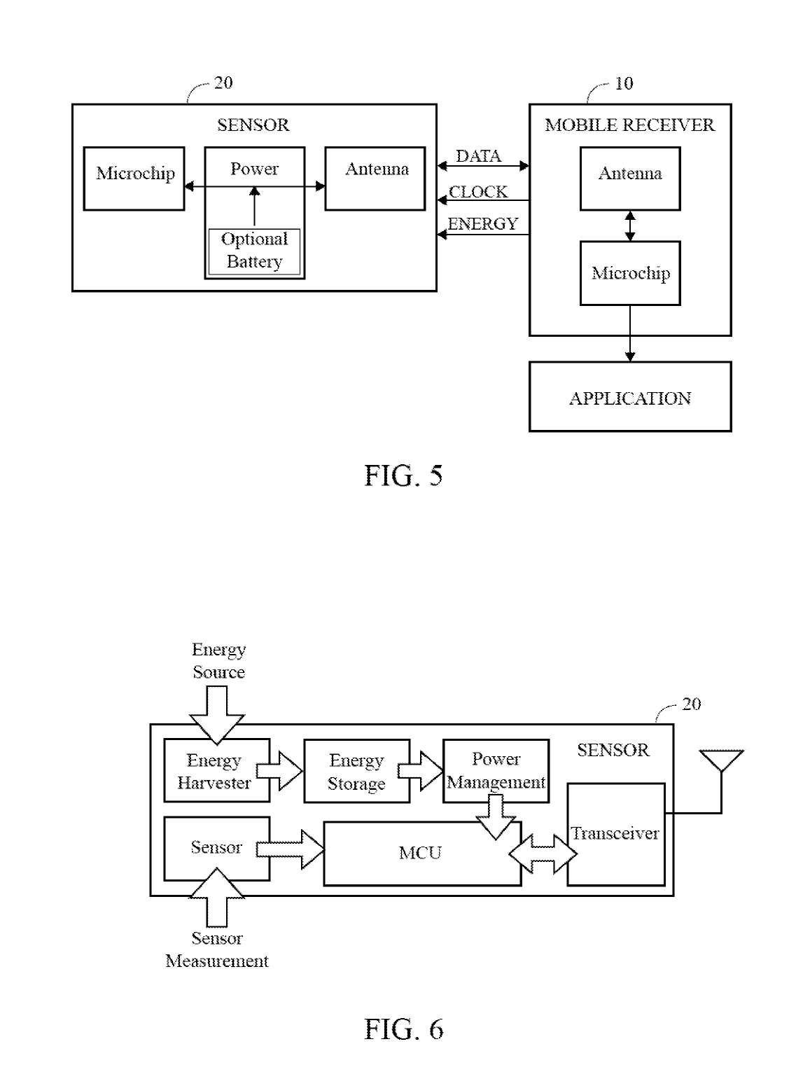

The present invention also provides energy harvesting advantages. FIGS. 5 and 6 show energy harvesting by a monitor 20. Sensor measurements are taken by the monitor and the data is stored in the microchip until the monitor 20 receives sufficient power to send the data to the receiver. An energy source provides for energy harvesting in order to store enough energy to power up the microchip of the monitor to communicate with the receiver passing over.

First, the repeater preferably uses a magnetic coupling approach to power sensors so that the sensors have no batteries (which is an RFID approach). In this embodiment, a stimulating coil (preferably the size of a hula hoop and in a horizontal orientation) passes over the monitor, which absorbs energy until a sufficient amount is harvested to allow it to make a measurement and transmit the data. Utilizing this approach makes sensors (depending on what is being sensed) extremely inexpensive. Also, the sensors are preferably the size of credit cards (or smaller), not much thicker, have no batteries, a simple uC, sensor circuitry, and a low cost, very low power, radio transmission scheme.

FIG. 5 shows the main components of the communication between an energy saving monitor 20 and a receiver 10. The monitor 20 has a microchip to store data, power management, which can include a battery, and an antenna. The receiver 10 has an antenna and a microchip, and the data received is sent to an application that processes the sensor measurements. The receiver 10 provides energy and clock synchronization to the monitor 20 and the monitor 20 transmits collected data to the receiver 10.

Also, even without energy harvest benefits, stimulating coils are useful in serving as a “tickler” to let monitor know it is time to broadcast. The tickler approach uses relatively simple circuits that can detect the presence of the stimulating coil and direct the microcontroller that it is time to wake up, make a measurement and communicate. The tickler approach is low cost and very low power (about 1 uA of current is used to monitor for the tickler). This very low current draw allows a lithium coin cell like battery to power a simple soil/air/crop canopy sensor for approximately 20 years. Unique power management techniques make it possible to use one or two of the coin cells to power a soil moisture sensor for similar time frames. The small size and low profile as well as no need to change the batteries allows for low cost over mold or even liquid dipping of the circuitry for water sealing.

Another benefit is a non-radio communication scheme. Due to the very short sensor repeater ranges and the ability to trigger the sensor to transmit with a tickler, an alternative embodiment eliminates some radio communication. For above ground monitors (or monitors with a short tether to the surface), an acoustic approach is used in that the monitor literally chirp the data to the repeater. Likewise, the tickler is acoustic as well.

The present invention allows for disposable monitors with an unprecedented spatial resolution within a crop.

The present invention is also applicable to lateral irrigation lines and even farm equipment—a sprayer equipped with differential GPS and the repeater travels along a course picking up sensor data along the way.

Alternative embodiments include a specially equipped cart used for a sport course to read a large number of inexpensive monitors.

In addition the present invention is also is amenable to environmental monitoring as well.

Alternatively, without the need to consider a lower cost, a hybrid application with the center pivot geometry is used with other repeaters strung down a center pivot and sensors at depths ranging between 6″-12″. Because center pivots move slowly (600 ft/hr on the outer reaches), monitors broadcasting once every ten minutes will have at least one broadcast from a range of 30 feet or less.

The most serious disadvantage to this approach is the lack of visibility to all monitors at all times, in that only the monitors very near the center pivot are visible. However, for irrigation management this is sufficient.

Also, repeaters utilized with the present invention in one embodiment are solar powered. In yet another alternative embodiment, the repeaters communicate wirelessly directly over a communications network.

The present invention may be used with a system and method such as disclosed in Glancy et al., U.S. patent application Ser. No. 12/983,241, filed on Dec. 31, 2010 for an Apparatus And Method For Wireless Real Time Measurement And Control Of Soil And Turf Conditions, which is hereby incorporated by reference in its entirety.

The present invention may be used with a system, sensor and method such as disclosed in Campbell, U.S. Pat. No. 7,482,820 for a Sensor For Measuring Moisture And Salinity, which is hereby incorporated by reference in its entirety.

The present invention may use a chemical sensor probe such as disclose in U.S. Pat. No. 4,059,499 which is hereby incorporated by reference in its entirety.

The present invention may use a chemical sensor probe such as disclose in U.S. Pat. No. 5,033,397 which is hereby incorporated by reference in its entirety.

The present invention may utilize the systems and methods disclosed in Magro et al., U.S. Pat. No. 8,340,910 for a Method And System For Monitoring Soil And Water Resources, which is hereby incorporated by reference in its entirety.

The present invention may also utilize the systems and methods disclosed in Magro et al., U.S. patent application Ser. No. 12/911,720, filed on Oct. 25, 2010 for a Method For Soil Analysis, which is hereby incorporated by reference in its entirety.

Magro et al., U.S. patent application Ser. No. 12/698,176, filed on Feb. 2, 2010 for a Method And System For Monitoring Soil And Water Resources is hereby incorporated by reference in its entirety.

Campbell et al., U.S. patent application Ser. No. 12/698,138, filed on Feb. 1, 2010 for a Method, System And Sensor For Performing Soil Measurements is hereby incorporated by reference in its entirety.

Campbell et al., U.S. Pat. No. 8,035,403 for a Wireless Soil Sensor Utilizing A RF Frequency For Performing Soil Moisture Measurements is hereby incorporated by reference in its entirety.

Campbell et al., U.S. Pat. No. 8,374,553 for a Method And System For Improving A Communication Range And Reliability Of A Soil Sensor Antenna is hereby incorporated by reference in its entirety.

Campbell et al., U.S. Pat. No. 8,368,529 for an Antenna Circuit Matching The Soil Conditions is hereby incorporated by reference in its entirety.

Campbell et al., U.S. patent application Ser. No. 12/697,283, filed on Jan. 31, 2010 for an Adaptive Irrigation Control is hereby incorporated by reference in its entirety.

Campbell et al., U.S. patent application Ser. No. 12/697,281, filed on Jan. 31, 2010 for an Irrigation Interrupter is hereby incorporated by reference in its entirety.

Campbell et al., U.S. Pat. No. 8,354,852 for a Wireless Soil Sensor Utilizing A RF Frequency For Performing Soil Moisture Measurements is hereby incorporated by reference in its entirety.

Campbell et al., U.S. Pat. No. 8,366,017 for a Method And System For Soil And Water Resources is hereby incorporated by reference in its entirety.

Campbell et al., U.S. Pat. No. 8,302,881 for a Method And System For Soil And Water Resources is hereby incorporated by reference in its entirety.

Systems, methods, sensors, controllers and interrupters for optimizing irrigation are disclosed in Campbell et al., U.S. Pat. No. 8,374,553, for a Method And System For Improving A Communication Range And Reliability Of A Soil Sensor Antenna, which is hereby incorporated by reference in its entirety.

Likewise, systems, methods, sensors, controllers and interrupters for optimizing irrigation are disclosed in Campbell et al., U.S. Pat. No. 8,308,077, for a Method And System For Soil And Water Resources, which is hereby incorporated by reference in its entirety.

Magro et al., U.S. patent application Ser. No. 13/017,538, filed on Jan. 31, 201 for an Automatic Efficient Irrigation Threshold Setting is hereby incorporated by reference in its entirety.

Campbell et al., U.S. patent application Ser. No. 13/662,909, filed on Oct. 29, 2012, for an Automatic Efficient Irrigation Threshold Setting is hereby incorporated by reference in its entirety.

Apruzzese et al., U.S. patent application Ser. No. 13/663,436, filed on Oct. 29, 2012, for an Irrigation Controller is hereby incorporated by reference in its entirety.

Sohrabi et al., U.S. patent application Ser. No. 13/663,442, filed on Oct. 29, 2012, for a RF Amplifier Tuning Method For Coping With Expected Variations In Local Dielectric is hereby incorporated by reference in its entirety.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes modification and substitutions of equivalents may be made therein without departing from the spirit and scope of this invention which is intended to be unlimited by the foregoing except as may appear in the following appended claim. Therefore, the embodiments of the invention in which an exclusive property or privilege is claimed are defined in the following appended claims.

I claim as my invention the following:

1. A system for data collection for agriculture, the system comprising:
a plurality of monitors, each of the plurality of monitors positioned in an agricultural area, each of the plurality of monitors comprising a transceiver, at least one sensor and an energy absorbing component;
a transport device, the transport device comprising an energy transfer component and a transceiver configured to receive a wireless signal;
wherein the transport device transfers an energy signal to each of the plurality of monitors as the transport device is within a predetermined distance of each of the plurality of monitors;
wherein each of the plurality of monitors receives the energy signal from the transport device and the energy signal powers a wireless signal from the transceiver of each of the plurality of monitors to the transceiver of the transport device, the wireless signal comprising agricultural data for the agricultural area.

2. The system according to claim 1 wherein the transport device is a drone aircraft.

3. The system according to claim 1 wherein the transport device is a tractor.

4. The system according to claim 1 wherein the transport device is a helicopter.

5. The system according to claim 1 wherein the energy component is an antenna for a passive RFID device, and the energy signal is a radiofrequency signal.

6. The system according to claim 1 wherein the energy component is an infrared photodetector, and the energy signal is an infrared signal.

7. The system according to claim 1 wherein the energy component is an ultrasound receiver, and the energy signal is an ultrasound signal.

8. A system for data collection for a geographical area, the system comprising:
a plurality of monitors, each of the plurality of monitors positioned in a geographical area, each of the plurality of monitors comprising a transceiver and at least one sensor;
a transport device, the transport device comprising a transceiver configured to transmit and receive wireless signals;
wherein the transport device transmits a wireless signal to each of the plurality of monitors as the transport device is within a predetermined distance of each of the plurality of monitors;
wherein each of the plurality of monitors receives the wireless signal from the transport device and the energy signal powers a wireless signal from the transceiver of each of the plurality of monitors to the transceiver of the transport device, the wireless signal comprising data for the geographical area.

9. The system according to claim 8 wherein each of the plurality of monitors comprises a proximity sensor configured to receive the wireless signal from the transport device, the proximity sensor configured to generate an activate signal for the monitor to activate, perform a measurement, and communicate the result in a wireless signal to the transport device.

10. The system according to claim 9 wherein each of the plurality of monitors comprises a battery.

11. The system according to claim 9 wherein the proximity sensor is an infrared photodetector, and the wireless signal is an infrared signal.

12. The system according to claim 9 wherein the proximity sensor is an ultrasound receiver, and the wireless signal is an ultrasound signal.

13. The system according to claim 8 wherein the transport device is one of irrigation center pivots, lateral lines, tractors, harvesters, motor vehicles, field man-transportable devices, and autonomous or semi-autonomous vehicles.

14. The system according to claim 8 wherein the geographical area is one of a sports field, a recreational field, a landfill, a waste site, a transportation infrastructure, and industrial process control site.

15. A system for data collection for a geographical area, the system comprising:
a plurality of monitors, each of the plurality of monitors positioned in a geographical area, each of the plurality of monitors comprising a transceiver and at least one sensor;
a transport device, the transport device comprising a transceiver configured to transmit and receive wireless signals;
at least one fixed receiver positioned in the geographical area;
wherein the transport device transmits a wireless signal to each of the plurality of monitors as the transport device is within a predetermined distance of each of the plurality of monitors;
wherein each of the plurality of monitors receives the wireless signal from the transport device and the energy signal powers a wireless signal from the transceiver of each of the plurality of monitors to the transceiver of the transport device, the wireless signal comprising data for the geographical area.

16. The system according to claim 15 wherein the fixed receiver is configured to receive and transmit data from each of the plurality monitors at fixed time intervals, and the wherein the transport device is configured to receive and transmit data from each of the plurality monitors at variable time intervals.

17. The system according to claim 15 wherein each of the plurality of monitors comprises a proximity sensor configured to receive the wireless signal from the transport device, the proximity sensor configured to generate an activate signal for the monitor to activate, perform a measurement, and communicate the result in a wireless signal to the transport device.

18. The system according to claim 17 wherein the proximity sensor is an infrared photodetector and the wireless signal is an infrared signal, or the proximity sensor is an ultrasound receiver, and the wireless signal is an ultrasound signal.

19. The system according to claim 15 wherein the transport device is one of irrigation center pivots, lateral lines, tractors, harvesters, motor vehicles, field man-transportable devices, and autonomous or semi-autonomous vehicles.

20. The system according to claim 15 wherein the geographical area is one of a sports field, a recreational field, a landfill, a waste site, a transportation infrastructure, and industrial process control site.
